(19) United States
(12) Patent Application Publication
(10) Pub. No.: US 2004/0040417 A1
(43) Pub. Date: Mar. 4, 2004

(54) Nail starter tool

(76) Inventor: James P. Davidson, Aptos, CA (US)

Correspondence Address: RICHARD BREWSTER MAIN, PATENT ATTORNEY, P.O. BOX 1859, LOS ALTOS, CA, 94022, US

(21) Appl. No.: 10/233,502

(22) Filed: Sep. 3, 2002

(51) Int. Cl. B25C 3/00

(52) U.S. Cl. 81/44

(57) ABSTRACT

A nail starter tool comprises a handle with a spring-loaded clip to retain a nail. A thumb release lever is squeezed by hand to open the jaws of the clip to receive a nail. The tool will then retain the nail until it is intentionally released by squeezing the thumb release lever. A groove in the jaws of the clip and a split well in the top of each jaw allow the nails to be easily loaded and held straight.

### BACKGROUND OF THE INVENTION

1. Field of the Invention

The present invention relates to hand tools, and more particularly to methods and devices for safely starting a nail while swinging a hammer, or screws without a starting hole.

2. Description of Related Art

Anyone who has used a hammer and nails has invariably injured their fingers while holding a nail to start its drive. Such experience is universally painful and can result in serious injury. At a minimum, the fingers that were struck with the hammer blow will be sore and tender. The work will not proceed as quickly.

Over the years, two basic ways have been tried to help hold and start a nail for the first blow that sets it in the workpiece. One holds the nail in place, ready to have the nail head struck with the hammer. The other attaches the nail itself temporarily to the hammer head. This latter method can result in the nail being mispositioned if the hammer swing on the first blow is not exact.

Jeffrey Bates describes a combination tool with nail starter in U.S. Pat. No. 5,933,894, issued Aug. 10, 1999. Nails are held by differently sized slots in a comb with a handle. Once the nail is started into the workpiece by striking the nailhead with a hammer, the comb is pulled back away to slip the nail out the slot. The implementation described combines the nail starter with a T-square and ruler.

Ralph Garcia illustrates a nail holder in United States Design Patent, Des. 371,286. A pliers type tool is apparently used to hold and grip a nail with one hand while a hammer is used to start the nail into the workpiece. The pliers illustrated has a very long neck and uses a pushrod to activate the jaws at the distal end. When the grip is released, the jaws will release the nail.

Such prior art nail starters and holders have proven to be too complex to manufacture economically. Some have also been hard to wield in confined spaces, like between studs in a wall. The four different diameter “through holes 13-16” described by Bates in U.S. Pat. No. 5,933,894, appear to be subject to deteriorating grip on the nails as they are subject to wear over time.

Habitat For Humanity is a charity that uses willing, amateur volunteer workers to help build homes for low-income families. Much of the work is donated, and uses unskilled but very enthusiastic people. One task, starting nails during framing, has been particularly troublesome for these newcomers. Many are injuring themselves swinging hammers at nails they are holding with their fingers, and others are too timid to really wallop the nails correctly. So a simple-to-use and effective tool is needed to help these new carpenters do their work.

### SUMMARY OF THE INVENTION

Briefly, a nail starter tool embodiment of the present invention comprises a handle with a spring-loaded clip to retain a nail, screw, or other fastener. A thumb release lever is squeezed by hand to open the jaws of the clip to receive the fastener. The tool will then retain the fastener until it is intentionally released by squeezing the thumb release lever. A groove in each jaw of the tool allows the fastener to be easily loaded and held straight. Such groove is tilted back in the tool so the handle can be angled away from the work and still drive the fastener in square.

An advantage of the present invention is a tool is provided for safely driving nails and other fasteners.

Another advantage of the present invention is that a nail-starter tool is provided that is simple, inexpensive, and effective.

A still further advantage of the present invention is that a nail-starter tool is provided that is compact, light, and easy to carry.

Another advantage of the present invention is its inherent safety when driving nails. Nails cannot spin out of control and the fingers are protected at all times.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1A is a top, plan view diagram of a nail-starter tool embodiment of the present invention, and is shown in a left-handed version with the jaws open to receive a nail;

FIG. 1B is a top, plan view diagram of the nail-starter tool of FIG. 1A, and is shown with the jaws closed to hold onto a nail;

FIG. 1C is a left side view diagram of the nail-starter tool of FIGS. 1A and 1B, and shows the tilted-back head;

FIG. 2A is a top, plan view diagram of a simplified nail-starter tool embodiment of the present invention, and is also shown in a left-handed version with the jaws open to receive a nail;

FIG. 2B is a top, plan view diagram of the simplified nail-starter tool of FIG. 1A, and is shown with the rocker arm closed to hold onto a nail;

FIG. 2C is a left side view diagram of the nail-starter tool of FIGS. 1A and 1B, and shows the tilted-back head; and

FIG. 2D is a left side view diagram of the rocker arm that pivotally attaches to the right side of the nail-starter tool of FIGS. 2A-2C.

### DETAILED DESCRIPTION OF THE INVENTION

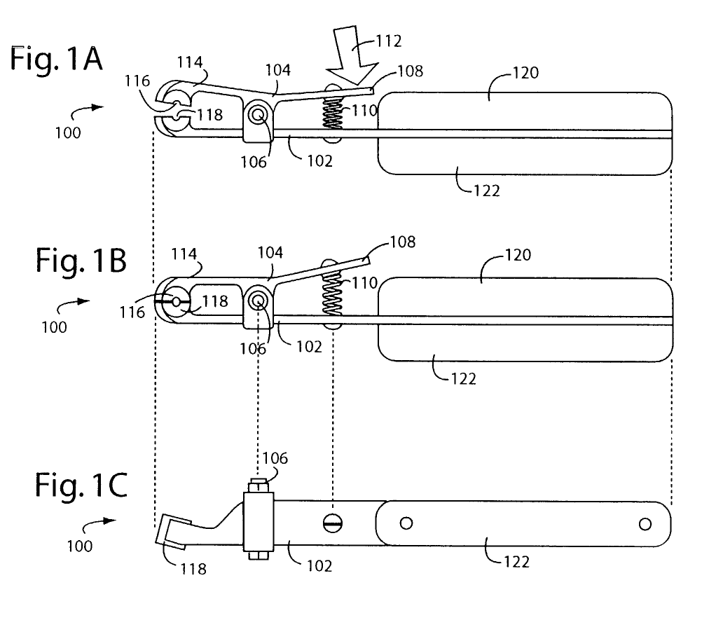

FIGS. 1A-1C illustrate a first nail-starter tool embodiment of the present invention, and is referred to herein by the general reference numeral 100. The tool 100 comprises a main handle 102 to which is fixed a pivotable clip 104 by a pivot 106. A near end 108 of the clip is squeezed by the user's left thumb to compress a spring 110. Such thumb pressure, represented by arrow 112 in FIG. 1A, will open a distal end 114 to separate a pair of nail jaws 116 and 118. A nail can then be introduced between these jaws that will be held securely for driving into a workpiece with a hammer in the user's other hand. A wide range of nail sizes and diameters can thus be readily accommodated.

FIG. 1B shows such nail jaws closed. A pair of handle grips 120 and 122 are fastened to either side of the handle 102 to make it more comfortable to use.

FIG. 1C shows the nail jaws 116 and 118 are angled back to allow nail to be set straight when the tool handle 102 is angled away from the surface of the workpiece. Such allows for a natural and comfortable use of the tools and hands.

The tool 100 of FIGS. 1A-1C is useful for starting all types of fasteners, not just nails. In particular, screws may be safely started with first punching a pilot hole or drilling a starting hole.

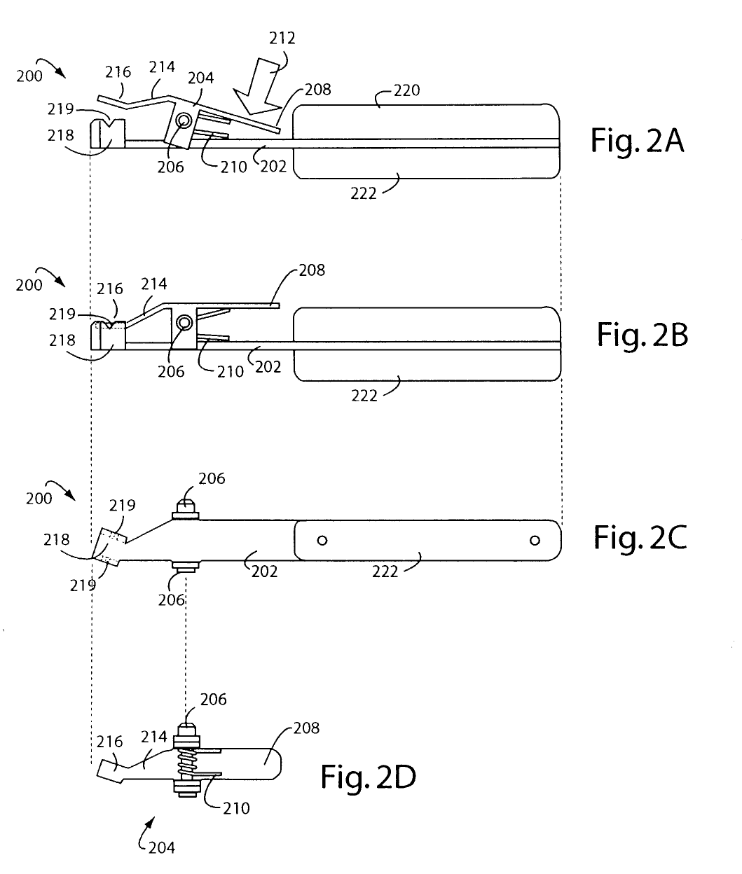

FIG. 2 illustrates a simplified nail-starter tool embodiment of the present invention, and is referred to herein by the general reference numeral 200. Compared to tool 100 of FIG. 1, tool 200 is less costly to manufacture, and yet still gives very good results. Its metal parts can be stamped from sheet metal. The tool 200 comprises a main handle 202 to which is fixed a rocker arm 204 by a pivot 206. A near end 208 of the clip is squeezed by the user's left thumb to torsion a twist spring 210. Such thumb pressure, represented by arrow 212 in FIG. 2A, will open a distal end 214 to separate a finger 216 that just fits inside the open end of a squared and notched U-channel 218.

A nail can thus be introduced that will be securely held by the finger 216 in a pair of top and bottom notches 219. Such nail is held at a tilt-back angle for driving into a workpiece with a hammer in the user's other hand. A wide range of nail sizes and diameters can thus be readily accommodated.

FIG. 2B shows such nail jaws closed. A pair of handle grips 220 and 222 are fastened to either side of the handle 202 to make it more comfortable to use.

FIG. 2C shows the tilt-back angle of notches 219 relative to one another that allows the near end of handle 202 to be held slightly aloft of the work. Such allows for a natural and comfortable use of the tools and hands.

FIG. 2D represents the rocker arm 204 after being removed from the rest of the tool 200. The twist spring 210 is captured on the shaft of pivot 206.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A nail-starter tool, comprising:
a handle for holding in one hand of a user while a hammer is being swung in the other hand of the user;
a clamp mounted on a distal end of the handle and having a tilt-back angle that allows a nail being held to be driven in square when the handle is held angled aloft from a workpiece;
a pivot disposed in the clamp that provides for an opening of a distal end of the clamp by a thumb of the user when loading in a nail to be driven into said workpiece;
a spring disposed in the clamp that provides for self-closing of said distal end of the clamp when said thumb of the user is removed, and that provides for holding said nail while being driven into said workpiece.

2. The nail-starter tool of claim 1, further comprising:
a two-part jaw disposed in the clamp that provides for holding said nail while being driven into said workpiece, and that splits apart in the middle when the clamp is opened by thumb pressure of said user against said spring.

3. The nail-starter tool of claim 1, further comprising:
a rocker arm pivotally disposed in the clamp that provides for holding said nail while being driven into said workpiece, and that rocks back to open at its distal end when the clamp is opened by thumb pressure of said user against said spring.

4. The nail-starter tool of claim 3, further comprising:
a finger extension disposed on the distal end of the rocker arm;
a U-channel with and open end that can be closed by the finger extension when the clamp is allowed to close under pressure of the spring; and
a pair of notches disposed one each in the two ends of U-channel and providing for the capture of said nail with the finger extension.
